(19) United States
(12) Patent Application Publication
(10) Pub. No.: US 2026/0219868 A1
(43) Pub. Date: Jul. 30, 2026

(54) CONTROL DEVICE AND CONTROL METHOD

(71) Applicant: TOYOTA JIDOSHA KABUSHIKI KAISHA, Toyota-shi (JP)

(72) Inventors: Shingo SUGIMOTO, Nagoya-shi (JP); Yuma ITO, Chiryu-shi (JP); Napak JENKITTIKUL, Kasugai-shi (JP)

(73) Assignee: TOYOTA JIDOSHA KABUSHIKI KAISHA, Toyota-shi (JP)

(21) Appl. No.: 19/418,197

(22) Filed: Dec. 12, 2025

(30) Foreign Application Priority Data
Jan. 29, 2025 (JP) 2025-013398

(51) Int. Cl. G06F 8/65; G07C 5/00

(52) U.S. Cl. CPC G06F 8/65; G07C 5/008

(57) ABSTRACT

A control device includes a controller configured to confirm a state of charge of an auxiliary battery provided in a vehicle, transmit, in a case where the state of charge is confirmed to be equal to or greater than a threshold value, to an ECU that is predetermined among one or more ECUs, a first instruction to start the ECU that is predetermined at a time point when a period that is predetermined has elapsed from a time point when the state of charge is confirmed to be equal to or greater than the threshold value, and to update data of the ECU that is predetermined by using predetermined data received from a server device, when the ECU that is predetermined is started.

### CROSS-REFERENCE TO RELATED APPLICATION

This application claims priority to Japanese Patent Application No. 2025-013398 filed on January 29, 2025. The disclosure of the above-identified application, including the specification, drawings, and claims, is incorporated by reference herein in its entirety.

### BACKGROUND

### 1. Technical Field

The present disclosure relates to a control device and a control method.

### 2. Description of Related Art

In the related art, a technique of updating data of an electronic control unit (ECU) provided in a vehicle is known. For example, Japanese Unexamined Patent Application Publication No. 2024-77160 (JP 2024-77160 A) discloses a technique that allows updating software in a case where a single-bank type computer and a dual-bank type computer are mixed as an in-vehicle ECU.

### SUMMARY

In a case where an auxiliary battery that supplies power to the ECU is becomes fully discharged during rewriting of data on the ECU, there is a problem that the rewriting of the data is not completed. Therefore, there is room for improvement in the technique of updating the data of the ECU provided in the vehicle.

An object of the present disclosure made in view of such circumstances is to improve a technique of updating data of an ECU provided in a vehicle.

A control device according to an embodiment of the present disclosure is a control device that updates data of one or more ECUs provided in a vehicle. The control device includes a controller configured to confirm, based on data measured by a state-of-charge sensor, a state of charge of an auxiliary battery provided in the vehicle, transmit, in a case where the state of charge is confirmed to be equal to or greater than a threshold value, to an ECU that is predetermined among the one or more ECUs, a first instruction to start the ECU that is predetermined at a time point when a period that is predetermined has elapsed from a time point when the state of charge is confirmed to be equal to or greater than the threshold value, and update data of the ECU that is predetermined by using predetermined data received from a server device, when the ECU that is predetermined is started.

A control device according to an embodiment of the present disclosure is a control device that updates data of one or more ECUs provided in a vehicle. The control device includes a controller configured to confirm a state of charge of an auxiliary battery provided in the vehicle, transmit, in a case where the state of charge is confirmed to be equal to or greater than a threshold value, to an ECU that is predetermined among the one or more ECUs, a first instruction to start the ECU that is predetermined at a time point when a period that is predetermined has elapsed from a time point when the state of charge is confirmed to be equal to or greater than the threshold value, and update data of the ECU that is predetermined by using predetermined data received from a server device, when the ECU that is predetermined is started.

A control method according to an embodiment of the present disclosure is a control method executed by a control device that updates data of one or more ECUs provided in a vehicle. The control method includes confirming a state of charge of an auxiliary battery provided in the vehicle, transmitting, in a case where the state of charge is confirmed to be equal to or greater than a threshold value, to an ECU that is predetermined among the one or more ECUs, a first instruction to start the ECU that is predetermined at a time point when a period that is predetermined has elapsed from a time point when the state of charge is confirmed to be equal to or greater than the threshold value, and updating data of the ECU that is predetermined by using predetermined data received from a server device, when the ECU that is predetermined is started.

According to the embodiment of the present disclosure, a technique of updating data of an ECU mounted in a vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration example of a system according to an embodiment of the present disclosure;

FIG. 2 is a flowchart showing an operation example of the control device; and

FIG. 3 is a diagram showing the operation example of the control device in time series.

### DETAILED DESCRIPTION OF EMBODIMENTS

### Overview of Embodiment

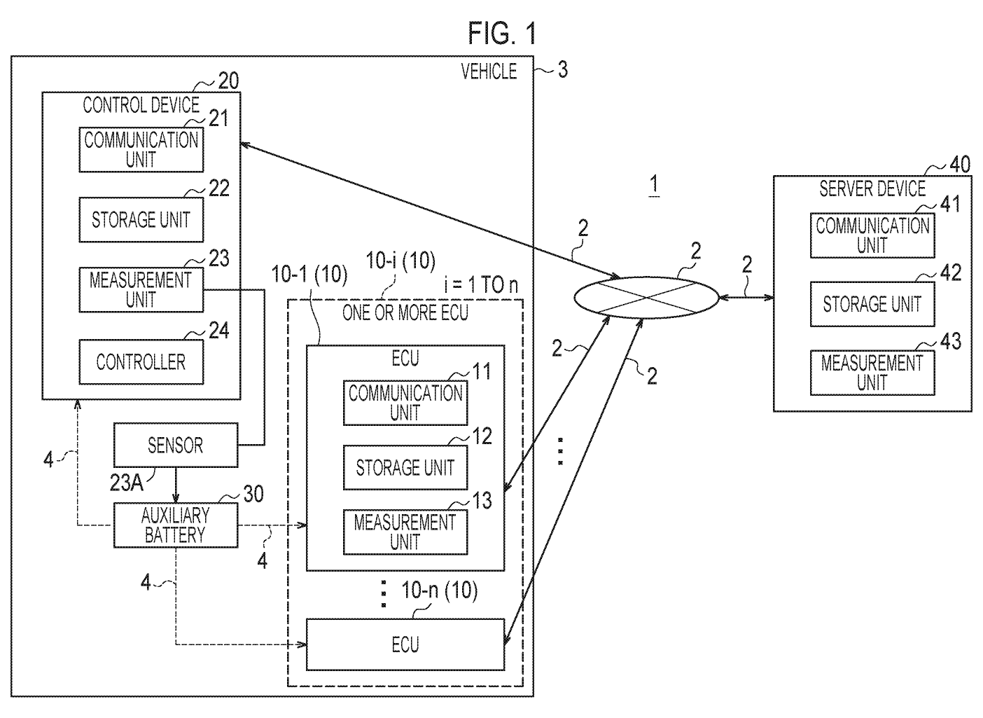

An overview of a system 1 according to an embodiment of the present disclosure will be described with reference to FIG. 1. The system 1 includes a vehicle 3, one or more ECUs 10-i (i = 1 to n) provided in the vehicle 3, a control device 20, an auxiliary battery 30, and a server device 40. The one or more ECUs 10-i, the control device 20, and the server device 40 are communicably connected to a network 2 including, for example, a mobile communication network, a wireless fidelity (Wi-Fi) mesh, or the like.

The vehicle 3 is, for example, an automobile such as a gasoline vehicle, a battery electric vehicle (BEV), a hybrid electric vehicle (HEV), a plug-in hybrid electric vehicle (PHEV), or a fuel cell electric vehicle (FCEV), but is not limited thereto.

The one or more ECUs 10-i (hereinafter, abbreviated as one or more ECUs 10) are electronic control devices that control various systems mounted in the vehicle 3. Software (data) written in each of the one or more ECUs 10 is updated via the network 2.

The control device 20 is a computer mounted in the vehicle 3. The control device 20 updates the data of the one or more ECUs 10 using data received from the server device 40.

The auxiliary battery 30 is a lithium ion battery, a nickel hydrogen battery, or the like, but is not limited thereto. The auxiliary battery 30 is a battery that supplies power to various electronic devices provided in the vehicle 3. In the example of FIG. 1, the auxiliary battery 30 supplies power to the one or more ECUs 10 and the control device 20 via a battery cable 4. The auxiliary battery 30 is charged during traveling. In addition, the auxiliary battery 30 is also used as a backup power source that stores settings of the one or more ECUs 10, the control device 20, and the like in a time slot in which the vehicle 3 is not used.

The server device 40 is, for example, a server that distributes update data in a case of wirelessly updating data incorporated in the ECU. The server device 40 may be mounted in a mobile object such as an automobile traveling side by side with the vehicle 3.

### Configuration of ECU

As shown in FIG. 1, each of the one or more ECUs 10 includes a communication unit 11, a storage unit 12, and a controller 13.

The communication unit 11 includes one or more communication interfaces for wirelessly connecting to the network 2. The communication interface connected to the network 2 corresponds to, for example, a communication standard such as Wi-Fi, 4th generation (4G), or 5th generation (5G). Each of the one or more ECUs 10-i communicates with the control device 20 via the network 2.

The storage unit 12 includes one or more memories. The memory is, for example, a semiconductor memory, but is not limited thereto. The storage unit 12 stores a system program, an application program, and the like (referred to as data in the present embodiment) that control the overall operation of each of the one or more ECUs 10. The data can be read and written by the controller 13.

The controller 13 includes one or more processors, one or more programmable circuits, one or more dedicated circuits, or a combination thereof, and controls the overall operation of each of the one or more ECUs 10.

### Configuration of Control Device

As shown in FIG. 1, the control device 20 includes a communication unit 21, a storage unit 22, a measurement unit 23, and a controller 24.

The communication unit 21 includes one or more communication interfaces for wirelessly connecting to the network 2. The communication interface connected to the network 2 corresponds to, for example, a communication standard such as Wi-Fi, 4G, or 5G. The control device 20 communicates with each of the one or more ECUs 10 and the server device 40 via the network 2.

The storage unit 22 includes one or more memories. The memory is, for example, a semiconductor memory, a magnetic memory, an optical memory, or the like, but is not limited thereto. The storage unit 22 may store, for example, a system program, an application program, and the like.

The measurement unit 23 includes a sensor 23A. The sensor 23A is a state-of-charge sensor that measures the state of charge of the auxiliary battery 30. However, the sensor 23A is not limited thereto.

The controller 24 includes one or more processors, one or more programmable circuits, one or more dedicated circuits, or a combination thereof, and controls the overall operation of the control device 20.

### Configuration of Server Device

As shown in FIG. 1, the server device 40 includes a communication unit 41, a storage unit 42, and a controller 43.

The communication unit 41 includes one or more communication interfaces for connecting to the network 2. The communication interface connected to the network 2 corresponds to, for example, a communication standard such as Wi-Fi, 4G, or 5G. The server device 40 communicates with the control device 20 via the network 2.

The storage unit 42 includes one or more memories. The memory is, for example, a semiconductor memory, a magnetic memory, an optical memory, or the like, but is not limited thereto. The storage unit 42 may store, for example, a system program, an application program, data for updating each of the one or more ECUs 10, and the like, which are used for the operation of the server device 40.

The controller 43 includes one or more processors, one or more programmable circuits, one or more dedicated circuits, or a combination thereof, and controls the overall operation of the server device 40.

### Operation Flow of Control Device

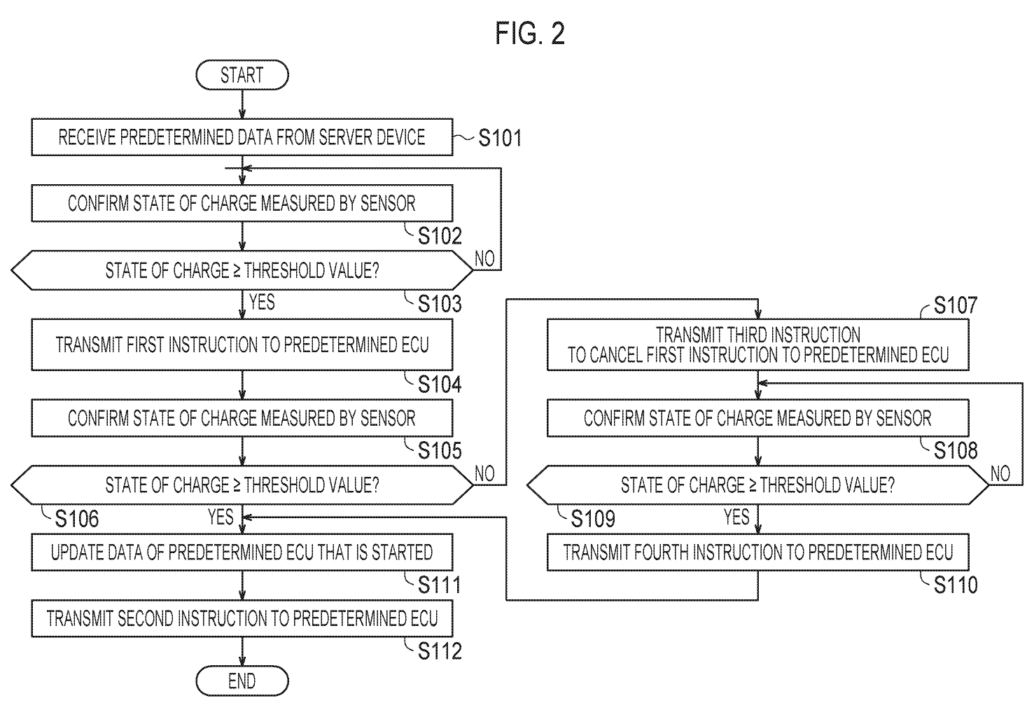

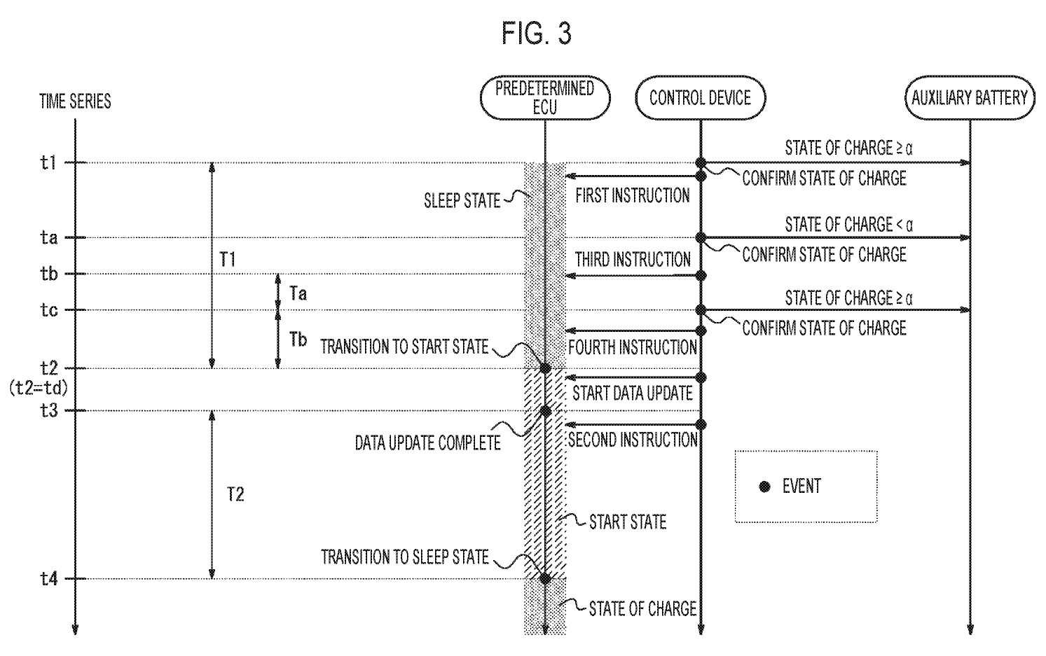

With reference to FIGS. 2 and 3, an operation example of the control device 20 according to the present embodiment will be described.

S101: The controller 24 receives predetermined data d from the server device 40.

The predetermined data d is update data of data written in the one or more ECUs 10.

S102: The controller 24 confirms a state of charge Wr of the auxiliary battery 30 based on data measured by the sensor 23A.

The sensor 23A is a state-of-charge sensor that measures the state of charge Wr of the auxiliary battery 30. As shown in FIG. 1, the auxiliary battery 30 supplies, via the battery cable 4, power to electronic devices such as the one or more ECUs 10 and the control device 20 provided in the vehicle 3. The state of charge Wr of the auxiliary battery 30 is reduced by the power supply.

S103: The controller 24 determines whether the state of charge Wr is equal to or greater than a threshold value α. In a case where the state of charge Wr is confirmed to be equal to or greater than the threshold value α, the process proceeds to S104, and in a case where the state of charge Wr is confirmed to be lower than the threshold value α, the process returns to S102.

The threshold value α is a minimum value of electric power required to operate the electronic devices of the vehicle 3. Therefore, when the state of charge Wr is lower than the threshold value α during the data update of each of the one or more ECUs 10, the amount of electric power used exceeds the state of charge Wr, and the power supply amount is insufficient, which results in a problem that the data update is not completed.

The auxiliary battery 30 is charged during traveling. Therefore, even in a case where the state of charge Wr is reduced to lower than the threshold value α, the state of charge Wr is recovered to a level equal to or greater than the threshold value α by traveling of the vehicle 3.

S104: The controller 24 transmits, to the predetermined ECU 10-1 among the one or more ECUs 10, a first instruction to start a predetermined ECU-1 at a time point t2 when a predetermined period T1 has elapsed from a time point t1. The time point t1 is a time point when the state of charge Wr is confirmed to be equal to or greater than the threshold value α.

In the present embodiment, the predetermined ECU 10-1 is an ECU that requires a data update among the one or more ECUs 10 provided in the vehicle 3. The first instruction is, for example, a command to start the predetermined ECU 10-1. As shown in

FIG. 3, the predetermined ECU 10 is in a sleep state for a predetermined period T1 from the time point t1 to the time point t2. The predetermined period T1 may be optionally set.

Steps S105 to S110 are steps of reconfirming the state of charge Wr in a time slot from the time point t1 to the time point t2. In a case where the state of charge Wr is reduced to lower than the threshold value α in the time slot, the controller 24 temporarily cancels the first instruction, and transmits a fourth instruction after the state of charge Wr is recovered to the level equal to or greater than the threshold value α.

S105: The controller 24 reconfirms the state of charge Wr of the auxiliary battery 30 after the first instruction is transmitted and before the predetermined ECU 10-1 is started.

S106: The controller 24 determines whether the state of charge Wr is equal to or greater than the threshold value α. In a case where the state of charge is confirmed to be equal to or greater than the threshold value α, the process proceeds to S111, and in a case where the state of charge is confirmed to be lower than the threshold value α, the process proceeds to S107.

S107: In a case where the state of charge Wr is confirmed to be reduced to lower than the threshold value α, the controller 24 transmits a third instruction (non-starting instruction) to cancel the first instruction to the predetermined ECU 10-1.

As shown in FIG. 3, the controller 24 confirms that the state of charge Wr is equal to or greater than the threshold value α at the time point t1. Thereafter, in a case where the state of charge Wr is confirmed to be reduced to lower than the threshold value α at a time point ta, the controller 24 transmits the third instruction to the predetermined ECU 10-1 at a time point tb. The third instruction is, for example, a command to cancel the first instruction that has already been transmitted.

S108: The controller 24 confirms the state of charge Wr of the auxiliary battery 30 at a time point when a predetermined period Ta has elapsed from the time point tb at which the third instruction is transmitted.

S109: The controller 24 determines whether the state of charge is recovered to the level equal to or greater than the threshold value α. In a case where the state of charge is confirmed to be recovered to the level equal to or greater than the threshold value α, the process proceeds to S110, and in a case where the state of charge is confirmed to be lower than the threshold value α, the process returns to S108.

S110: In a case where the state of charge Wr is confirmed to be recovered to the level equal to or greater than the threshold value α, the controller 24 transmits, to the predetermined ECU 10-1, a fourth instruction to start the predetermined ECU 10-1 at a time point td. The time point td is a time point when a predetermined period Tb has elapsed from the time point tc when the state of charge Wr is confirmed to be recovered to the level equal to or greater than the threshold value α.

In a case where that the state of charge Wr is confirmed to be recovered to the level equal to or greater than the threshold value α at the time point tc, the controller 24 transmits, to the predetermined ECU 10-1, a command to start the predetermined ECU-1 at the time point td when the predetermined period Tb has elapsed from the time point tc. The predetermined period Tb may be optionally set.

S111: The controller 24 updates the data of the predetermined ECU-1 using the predetermined data d received from the server device 40, when the predetermined ECU-1 is started.

When the predetermined ECU-1 is confirmed to be started at the time point t2 (or the time point td), the controller 24 transmits the predetermined data d to the predetermined ECU-1. Further, the controller 24 transmits a command to update (rewrite) the data of the predetermined ECU-1. In the example of FIG. 3, the time point t2 and the time point td are assumed to be the same time point. Hereinafter, the time point t2 and the time point td are the same time point.

S112: In a case where the update of the data of the predetermined ECU 10-1 is confirmed to be completed, the controller 24 transmits, to the predetermined ECU 10-1, a second instruction to transition the predetermined ECU 10-1 to a sleep state at a time point t4. The time point t4 is a time point when a predetermined period T2 has elapsed from the time point t3 at which the data update is completed.

The second instruction is a command to transition the predetermined ECU 10-1 to the sleep state. As shown in FIG. 3, the predetermined ECU-1 is started at the time point t2, the data update is completed at the time point t3, and the predetermined ECU-1 transitions to the sleep state at the time point t4 in response to the second instruction. That is, the predetermined ECU-1 is in the start state from the time point t2 to the time point t4. The predetermined period T2 may be optionally set.

As described above, the control device 20 according to the present embodiment confirms the state of charge of the auxiliary battery 30 provided in the vehicle 3. In a case where the state of charge is confirmed to be equal to or greater than the threshold value, the control device 20 transmits, to the predetermined ECU 10-1 among the one or more ECUs 10-i, the first instruction to start the predetermined ECU 10-1 at a time point when the predetermined period has elapsed from the time point when the state of charge is confirmed to be equal to or greater than the threshold value. The control device 20 updates the data of the predetermined ECU 10-1 using the predetermined data received from the server device 40 when the predetermined ECU 10-1 is started.

According to such a configuration, before the data of the predetermined ECU 10-1 is updated, whether the state of charge of the auxiliary battery 30 is equal to or greater than the threshold value α is confirmed. Therefore, for example, it is possible to prevent the occurrence of a problem that the data rewriting is not completed due to the auxiliary battery 30 being drained during the data rewriting. Therefore, the technique of updating the data of the ECU provided in the vehicle is improved in that it is possible to control a timing of rewriting the data in accordance with the state of charge of the auxiliary battery 30.

Although the disclosure has been described with reference to drawings and examples, it should be noted that various variations and modifications may be made by those skilled in the art based on the disclosure. Therefore, it should be noted that the variations and modifications fall within the scope of the disclosure. For example, functions included in each component or each step can be rearranged so as not to be logically inconsistent, and multiple components or steps can be combined together or separated.

In addition, for example, an embodiment in which a general-purpose computer functions as the control device 20 according to the above-described embodiment is also possible. Specifically, a program describing processing contents that realize each function of the control device 20 according to the above-described embodiment is stored in a memory of the general-purpose computer, and the program is read and executed by a processor. Therefore, the present disclosure can also be realized as a program that can be executed by a processor or a non-transitory computer-readable medium that stores the program.

What is claimed is:

1. A control device that updates data of one or more ECUs provided in a vehicle, the control device comprising a controller configured to:
confirm, based on data measured by a state-of-charge sensor, a state of charge of an auxiliary battery provided in the vehicle;
transmit, in a case where the state of charge is confirmed to be equal to or greater than a threshold value, to an ECU that is predetermined among the one or more ECUs, a first instruction to start the ECU that is predetermined at a time point when a period that is predetermined has elapsed from a time point when the state of charge is confirmed to be equal to or greater than the threshold value; and
update data of the ECU that is predetermined by using predetermined data received from a server device, when the ECU that is predetermined is started.

2. A control device that updates data of one or more ECUs provided in a vehicle, the control device comprising a controller configured to:
confirm a state of charge of an auxiliary battery provided in the vehicle;
transmit, in a case where the state of charge is confirmed to be equal to or greater than a threshold value, to an ECU that is predetermined among the one or more ECUs, a first instruction to start the ECU that is predetermined at a time point when a period that is predetermined has elapsed from a time point when the state of charge is confirmed to be equal to or greater than the threshold value; and
update data of the ECU that is predetermined by using predetermined data received from a server device, when the ECU that is predetermined is started.

3. The control device according to claim 2, wherein the controller is configured to transmit, in a case where completion of update of the data of the ECU that is predetermined is confirmed, to the ECU that is predetermined, a second instruction to cause the ECU that is predetermined to transition to a sleep state at a time point when a period that is predetermined has elapsed from a time point when the update of the data is completed.

4. The control device according to claim 2, wherein the controller is configured to confirm the state of charge after the first instruction is transmitted and before the ECU that is predetermined is started, and transmit, in a case where the state of charge is confirmed to have decreased below the threshold value, to the ECU that is predetermined, a third instruction to cause the ECU that is predetermined to cancel the first instruction.

5. The control device according to claim 4, wherein the controller is configured to confirm the state of charge when a period that is predetermined has elapsed from a time point when the third instruction is transmitted, and in a case where the state of charge is confirmed to have recovered to a level equal to or greater than the threshold value, to transmit, to the ECU that is predetermined, a fourth instruction to start the ECU that is predetermined at a time point when a period that is predetermined has elapsed from a time point when the state of charge is confirmed to have recovered to the level equal to or greater than the threshold value.

6. A control method executed by a control device that updates data of one or more ECUs provided in a vehicle, the control method comprising:
confirming a state of charge of an auxiliary battery provided in the vehicle;
transmitting, in a case where the state of charge is confirmed to be equal to or greater than a threshold value, to an ECU that is predetermined among the one or more ECUs, a first instruction to start the ECU that is predetermined at a time point when a period that is predetermined has elapsed from a time point when the state of charge is confirmed to be equal to or greater than the threshold value; and
updating data of the ECU that is predetermined by using predetermined data received from a server device, when the ECU that is predetermined is started.
